(19) United States
(12) Patent Application Publication
(10) Pub. No.: US 2018/0273736 A1
(43) Pub. Date: Sep. 27, 2018

(54) COMPOSITES REINFORCED FOR ELASTIC SUBSTANCE AND THE MANUFACTURING METHOD FOR THE SAME

(71) Applicant: Taiwan Carbon Nano Technology Corporation, Miaoli County (TW)

(72) Inventors: Chia-Hung Li, Miaoli County (TW); Ching-Tung Hsu, Miaoli County (TW); Chiun-Shian Tsai, Miaoli County (TW); Ting-Chuan Lee, Miaoli County (TW); Chiun-Rung Tsai, Miaoli County (TW)

(73) Assignee: Taiwan Carbon Nano Technology Corporation, Miaoli County (TW)

(21) Appl. No.: 15/928,461

(22) Filed: Mar. 22, 2018

(30) Foreign Application Priority Data
Mar. 23, 2017 (TW) 106109819

(51) Int. Cl. C08L 9/06; C08J 3/24; C08J 3/20

(52) U.S. Cl. CPC C08L 9/06; C08J 3/24; C08J 2491/00; C08J 2309/06; C08J 3/203

(57) ABSTRACT

A method for manufacturing an anti-aging rubber is disclosed. The method includes the following steps: adding and mixing one of a carbon tube material and a graphene material into a rubber-processing oil consistently to obtain a rubber-reinforced composite; and mixing the rubber-reinforced composite with a main rubber, a filler and a crosslinking agent.

### CROSS-REFERENCE TO RELATED APPLICATION AND CLAIM OF PRIORITY

The application claims the benefit of Taiwan Patent Application No. 106109819, filed on Mar. 23, 2017, at the Taiwan Intellectual Property Office, the disclosures of which are incorporated herein in their entirety by reference.

### FIELD OF THE INVENTION

The present invention relates to a composite reinforced for elastic substance and the manufacturing method for the same, and more particularly to a composite reinforced for a rubber or a silicone and the manufacturing method for the same.

### BACKGROUND OF THE INVENTION

In the past, in the production of rubber, the nano carbon and the processing oil were generally directly mixed in the rubber process. The rubber can be natural rubber, general purpose rubber or special synthetic rubber. The defects of this method are (1) flying powder in the stirring process; (2) after the mixture of the rubber processing oil, increasing the rubber plasticity, but lowering the wear resistance, worsening aging resistance, reducing the physical properties (tensile stress, module or tearing strength) and the conductivity of the rubber at the same time.

In order to overcome the drawbacks in the prior art, a composite reinforced for elastic substance and the manufacturing method for the same are disclosed. The particular design in the present invention not only solves the problems described above, but is also easy to implement. Thus, the present invention has utility for industry.

### SUMMARY OF THE INVENTION

The present invention is related to a rubber reinforced processing of polymer material containing nano carbon material ((single layer, few layers and multiple layers nano carbon tube), graphene and microfilm graphene). The use of this rubber reinforced processing of polymer material in the stirring process will not result in flying powder. The rubber reinforced processing of polymer material of the present application has a viscosity higher than that of the original rubber-processing oil (silicone oil, paraffinic rubber-processing oil, high naphthenic rubber processing oil and TDAE rubber-processing oil), and the viscosity ranges from 1000 cps to 300,000 cps. The rubber reinforced processing of polymer material makes the hardness value of the rubber increase by less than 3 degrees, and that increases the values of tensile strength, tearing strength and elongation at the same time; or by making the hardness value of the rubber increase by less than 3 degrees, it will improve the aging resistance of the rubber and increase the conductivity of the rubber (reducing surface resistance and bulk resistance).

In accordance with one aspect of the present invention, a method for manufacturing an anti-aging rubber is disclosed. The method includes the following steps: adding and mixing one of a carbon tube material and a graphene material into a rubber-processing oil consistently to obtain a rubber-reinforced composite; and mixing the rubber-reinforced composite with a main rubber, a filler and a crosslinking agent.

In accordance with another aspect of the present invention, a reinforced composite for an elastic material is disclosed. The reinforced composite includes a carbon material; and an elastic material processing oil mixed with the carbon material, wherein the reinforced composite has a viscosity ranging from 1000 cps to 300,000 cps.

In accordance with a further aspect of the present invention, a manufacturing method of a reinforced composite for an elastic material is disclosed. The manufacturing method includes the following steps: providing a carbon material; providing an elastic material processing oil; and mixing the carbon material and the elastic material processing oil.

The objectives and advantages of the present invention will become more readily apparent to those ordinarily skilled in the art after reviewing the following detailed descriptions and accompanying drawings, in which:

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; they are not intended to be exhaustive or to be limited to the precise form disclosed.

The present invention relates to a method for manufacturing an anti-aging rubber or silicone. The reinforced composite is added in the manufacturing process of the rubber or silicone to make its product properties better. The nano carbon tube or graphene is added into the processing oil of rubber or silicone, and is fully mechanically dispersed, such as by a roller type ball-mixing dispersion, a blade shear stirring dispersion and a high-pressure homogeneous dispersion which are shear mechanical modes, to manufacture the reinforced composite containing nano carbon tube/graphene. The manufacturing process is heated from 30 to 100° C. The nano carbon tube or graphene can be subjected to a surface treatment, and the surface treatment is a physical modification or a chemical modification. The chemical modification (such as a chemical graft modification) can be done by adding a coupling agent (such as a silane coupling agent or a titanate coupling agent) to modify the carbon tube to increase the mechanical strength of the rubber or silicone material. The physical modification can be a plasma treatment. The rubber or silicone processing oil is a processing oil with different proportions of paraffin, naphthenic or aromatic. The type of processing oil is a high naphthenic processing oil, an environmentally friendly rubber-processing oil TDAE, a paraffinic rubber-processing oil or a silicone rubber-processing oil (silicone oil). In addition, in the manufacturing process of non-silicone rubber (such as synthetic rubber), a processing aid can be added, such as glycol (such as PEG) or plasticizer, so that the viscosity of the reinforced composite is higher than the commercial rubber or silicone processing oil, which ranges from 1000 cps to 300,000 cps. Then, the reinforced composite is mixed with a main rubber, a filler and a crosslinking agent. A ratio of the nano carbon tube or the graphene to the reinforced composite is 0.001˜30 wt %, preferably 0.1˜5 wt %. The filler is a carbon black, a silica, a carbon fiber or a glass fiber.

The above mentioned reinforced composite makes the hardness value of the rubber or silicone product increase by less than 3 degrees, and it increases the values of tensile strength, tearing strength and elongation at the same time; or by making the hardness value increase by less than 3 degrees, it will improve the aging resistance of the rubber or silicone product at the same time. The reinforced composite is less than 20 parts per hundred of rubber (phr) when manufacturing the rubber or silicone, preferably less than 10 phr. The reinforced composite can make the rubber or silicone aging resistance higher, and it can make the product properties of tire tread (top and bottom) glue, tire (lateral) side glue and lining better. When the tread glue is added with the above mentioned reinforced composite, the aging resistance is increased to prolong the tire usage duration or the total amount of the tread glue can be reduced to make the tire weight lighter and the energy consumption lower while the tire is running, and thus the cost is reduced. In addition, adding the reinforced composite can increase the conductivity of the rubber or silicone slightly (resistivity is reduced within 100 folds). For example, the surface resistivity in Embodiment 1 is reduced from 3.6×10⁴ ohms/sq to 1.8×10⁴ ohms/sq.

### Embodiment 1

SBR rubber mixed with—10 phr high naphthenic rubber oil v.s. 10 phr reinforced composite (i.e. containing carbon tube and high naphthenic rubber-processing oil) (such as a gel form)

### Test Formula

| Components | formula 1 (phr) | formula 2 (phr) |
|---|---|---|
| SBR-1502 | 100 | 100 |
| Zinc oxygen powder | 40 | 40 |
| Stearic acid | 10 | 10 |
| DM | 7 | 7 |
| CZ | 7 | 7 |
| RD old anti-agent | 10 | 10 |
| 3C old anti-agent | 10 | 10 |
| S (sulfur) | 18 | 18 |
| N330 | 50 | 50 |
| High naphthenic rubber oil | 10 | |
| Reinforced composite | | 10 |
| containing carbon tube and | | |
| high naphthenic | | |
| rubber-processing oil | | |

### Test Data

| Test formula | formula 1 | formula 2 |
|---|---|---|
| Hardness | 60 | 60 |
| Power (Kg) | 20.85 | 26.33 |
| Tensile stress (Kg/cm²) | 177.89 | 214.35 |
| Elongation (%) | 288.91 | 404.77 |
| Tearing strength (Kg/cm) | 69.84 | 84.81 |
| Surface resistivity (ohms/sq) | 3.6 × 10⁴ | 1.8 × 10⁴ |

### Embodiment 2

SBR rubber mixed with—10 phr environmentally friendly rubber-processing oil TDAE v.s. 10 phr reinforced composite (i.e. containing carbon tube and environmentally friendly rubber-processing oil TDAE)

### Test Formula

| Components | formula 3 (phr) | formula 4 (phr) |
|---|---|---|
| SBR-1502 | 100 | 100 |
| Zinc oxygen powder | 40 | 40 |
| Stearic acid | 10 | 10 |
| DM | 7 | 7 |
| CZ | 7 | 7 |
| RD old anti-agent | 10 | 10 |
| 3C old anti-agent | 10 | 10 |
| S (sulfur) | 18 | 18 |
| N330 | 50 | 50 |
| TDAE processing oil | 10 | |
| Reinforced composite | | 10 |
| containing carbon tube and | | |
| TDAE processing oil | | |

### Test Data

| Test formula | formula 3 | formula 4 |
|---|---|---|
| Hardness | 60 | 60 |
| Power (Kg) | 24.48 | 28.65 |
| Tensile stress (Kg/cm²) | 217.73 | 236.41 |
| Elongation (%) | 622.62 | 685.15 |
| Tearing strength (Kg/cm) | 70.1 | 80.1 |
| Surface resistivity (ohms/sq) | 1.17E+05 | 3.86E+04 |
| Crack growth characteristics | Start to crack after | obviously crack after |
| of the test | 10,000 times; | 80,000 times |
| | obviously crack after | |
| | 30,000 times | |

The above crack growth test specification uses test specification-ASTM D813, the testing method is De Mattia Flexing machine, and the test conditions are 150° C., 5 Hz of frequency and 57 mm of folding trip. Starting to crack indicates the width of a split less than 0.1 mm, and obviously crack indicates the width of a split less than 0.2 mm.

### Embodiment 3

SBR rubber mixed with—10 phr environmental friendly rubber-processing oil TDAE v.s. 10 phr and 20 phr reinforced composites (i.e. containing graphene and environmental friendly rubber-processing oil TDAE)

Test formula:

| | formula 5 | formula 6 | formula 7 |
|---|---|---|---|
| Components | (phr) | (phr) | (phr) |
| SBR-1502 | 100 | 100 | 100 |
| Zinc oxygen powder | 40 | 40 | 40 |
| Stearic acid | 10 | 10 | 10 |
| DM | 7 | 7 | 7 |
| CZ | 7 | 7 | 7 |
| RD old anti-agent | 10 | 10 | 10 |
| 3C old anti-agent | 10 | 10 | 10 |
| S (sulfur) | 18 | 18 | 18 |
| N330 | 50 | 50 | 50 |
| TDAE processing oil | 10 | | |
| Reinforced composite | | 10 | 20 |
| containing graphene and | | | |
| TDAE processing oil | | | |

### Test Data

| Test formula | formula 5 | formula 6 | formula 7 |
|---|---|---|---|
| Hardness | 60 | 60 | 60 |
| Tensile stress (Kg/cm²) | 217.73 | 251.97 | 255.65 |
| Elongation (%) | 622.62 | 627.03 | 704.46 |
| Specific surface | 1.17E+05 | 9.27E+03 | 4.74E+03 |
| resistivity (ohms/sq) | | | |

From the above Embodiments 1-3, it is found that the rubber mixed with the reinforced composite of the present invention, no matter what kind of processing oil is added to the carbon tube or graphene, the tensile stress, elongation and tearing strength are increased, and the surface resistivity is reduced slightly, which represents increased physical properties, improved aging resistance and enhanced antistatic characteristics of the rubber. In Embodiment 2, it is further found that the formula of general TDAE starts to crack after 10,000 times and obviously cracks after 30,000 times in the crack growth characteristics of the test, but the formula added with the reinforced composite of the present application can delay the occurrence of crack until 80,000 times in the test.

### Embodiment 4

### Test Formula

| | | Rubber- | Rubber- | Rubber- |
|---|---|---|---|---|
| | | reinforced | reinforced | reinforced |
| | | composite | composite | composite |
| | | containing | containing | containing |
| | | carbon tube | carbon tube | carbon tube |
| | Original | and TDAE | and TDAE | and TDAE |
| | material | #1 | #2 | #3 |
| SBR | 76 | 76 | 76 | 76 |
| BR | 24 | 24 | 24 | 24 |
| carbon black | 85 | 85 | 85 | 85 |
| Zinc oxygen | 3 | 3 | 3 | 3 |
| powder | | | | |
| Stearic acid | 1 | 1 | 1 | 1 |
| Oil | 12.5 | 10.5 | 7.5 | 0.5 |
| Promoter | 1.7 | 1.7 | 1.7 | 1.7 |
| S (sulfur) | 2 | 2 | 2 | 2 |
| Rubber- | 0 | 2 | 5 | 12 |
| reinforced | | | | |
| composite | | | | |

SBR is an oil-filled SBR, such as SBR-1723, SBR-1712 oil-filled rubbers or SSBR rubber.

### Test Data

| | Rubber- | Rubber- | Rubber- |
|---|---|---|---|
| | reinforced | reinforced | reinforced |
| | composite | composite | composite |
| | containing | containing | containing |
| | carbon tube | carbon tube | carbon tube |
| Original | and TDAE | and TDAE | and TDAE |
| material | #1 | #2 | #3 |

The tensile properties made by rubber vulcanization under
165▭ and 15 minutes:

| | | | | |
|---|---|---|---|---|
| Hardness | 68 | 68 | 68 | 66 |
| Tensile stress | 202 | 199 | 211 | 195 |
| (Kg/cm²) | | | | |
| Elongation (%) | 529 | 528 | 523 | 692 |
| 300% M | 100 | 99 | 105 | 68 |
| Tearing strength | 36 | 41 | 34 | 33 |
| (Kg/cm) | | | | |

The tensile properties after aging process under 100▭ and 48 hours:

| | | | | |
|---|---|---|---|---|
| Hardness | 74 | 74 | 74 | 71 |
| Tensile stress | 184 | 192 | 186 | 186 |
| (Kg/cm²) | | | | |
| Elongation (%) | 393 | 417 | 390 | 532 |
| 300% M | 135 | 136 | 142 | 94 |
| Tearing strength | 19 | 32 | 21 | 27 |
| (Kg/cm) | | | | |
| Tensile strength | 91.09% | 96.48% | 88.15% | 95.38% |
| retention | | | | |
| Elongation (%) | 74.29% | 78.98% | 74.57% | 77.02% |
| retention | | | | |

From Embodiment 4, it can be realized that when adding 2 phr, 5 phr and 12 phr reinforced composites, the reinforced composite with 2 phr has excellent performance in the aspects of tensile strength and tearing strength.

For Embodiments 1-4 in general terms, the addition of the reinforced composite can be less than 20 phr, preferably less than 10 phr.

### Embodiments

1. A method for manufacturing an anti-aging rubber, comprising the following steps: adding and mixing one of a carbon tube material and a graphene material into a rubber-processing oil consistently to obtain a rubber-reinforced composite; and mixing the rubber-reinforced composite with a main rubber, a filler and a crosslinking agent.

2. The method as in Embodiment 1, wherein a ratio of one of the carbon tube material and the graphene material to the rubber-reinforced composite is 0.001˜30 wt %.

3. The method as in Embodiments 1-2, wherein a ratio of one of the carbon tube material and the graphene material to the rubber-reinforced composite is 0.1-5 wt %.

4. The method as in Embodiments 1-3, wherein a ratio of the filler to the main rubber is 10˜75%.

5. The method as in Embodiments 1-4, wherein a ratio of the filler to the main rubber is 25˜50%.

6. The method as in Embodiments 1-5, wherein the filler is one selected from a group from a carbon black, a silica, a carbon fiber and a glass fiber.

7. A reinforced composite for an elastic material, comprising:

a carbon material; and an elastic material processing oil mixed with the carbon material, wherein the reinforced composite has a viscosity ranging from 1000 cps to 300,000 cps.

8. The reinforced composite as in Embodiment 7, wherein the reinforced composite is less than 20 parts per hundred of rubber (phr) when manufacturing the elastic material.

9. The reinforced composite as in Embodiments 7-8, wherein the reinforced composite is less than 10 parts per hundred of rubber (phr) when manufacturing the elastic material.

10. A manufacturing method of a reinforced composite for an elastic material, comprising the following steps: providing a carbon material; providing an elastic material processing oil; and mixing the carbon material and the elastic material processing oil.

11. The method as in Embodiment 10, wherein the carbon material is one of a nano carbon tube material and a graphene material.

12. The method as in Embodiments 10-11, wherein the elastic material is one of a rubber and a silicone.

13. The method as in Embodiments 10-12, wherein the elastic material has a Young's modulus less than 1400 MPa.

14. The method as in Embodiments 10-13, wherein the mixing step is subject to at least one selected from the group consisting of a roller type ball-mixing dispersion, a blade shear stirring dispersion and a high-pressure homogeneous dispersion.

15. The method as in Embodiments 10-14, wherein the elastic material processing oil includes at least one selected from the group consisting of a high naphthenic processing oil, an environmentally friendly rubber-processing oil TDAE, a paraffinic rubber-processing oil and a silicone rubber-processing oil (silicone oil).

16. The method as in Embodiments 10-15, wherein the carbon material is subjected to a surface treatment in advance.

17. The method as in Embodiments 10-16, wherein the surface treatment includes one of a physical modification and a chemical modification.

18. The method as in Embodiments 10-17, wherein the carbon material and the elastic material processing oil are mixed uniformly

Based on the above, the present invention effectively solves the problems and drawbacks in the prior art, and thus it meets the demands of the industry and is of value.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing an anti-aging rubber, comprising the following steps:
adding and mixing one of a carbon tube material and a graphene material into a rubber-processing oil consistently to obtain a rubber-reinforced composite; and
mixing the rubber-reinforced composite with a main rubber, a filler and a crosslinking agent.

2. The method as claimed in claim 1, wherein a ratio of one of the carbon tube material and the graphene material to the rubber-reinforced composite is 0.001˜30 wt %.

3. The method as claimed in claim 2, wherein a ratio of one of the carbon tube material and the graphene material to the rubber-reinforced composite is 0.1˜5 wt %.

4. The method as claimed in claim 1, wherein a ratio of the filler to the main rubber is 10˜75%.

5. The method as claimed in claim 4, wherein a ratio of the filler to the main rubber is 25˜50%.

6. The method as claimed in claim 1, wherein the filler is one selected from a group consisting of a carbon black, a silica, a carbon fiber and a glass fiber.

7. A reinforced composite for an elastic material, comprising:
a carbon material; and
an elastic material processing oil mixed with the carbon material, wherein the reinforced composite has a viscosity ranging from 1000 cps to 300,000 cps.

8. The reinforced composite as claimed in claim 7, wherein the reinforced composite is less than 20 parts per hundred of rubber (phr) when manufacturing the elastic material.

9. The reinforced composite as claimed in claim 8, wherein the reinforced composite is less than 10 parts per hundred of rubber (phr) when manufacturing the elastic material.

10. A manufacturing method of a reinforced composite for an elastic material, comprising the following steps:
providing a carbon material;
providing an elastic material processing oil; and
mixing the carbon material and the elastic material processing oil.

11. The method as claimed in claim 10, wherein the carbon material is one of a nano carbon tube material and a graphene material.

12. The method as claimed in claim 10, wherein the elastic material is one of a rubber and a silicone.

13. The method as claimed in claim 10, wherein the elastic material has a Young's modulus less than 1400 MPa.

14. The method as claimed in claim 10, wherein the mixing step is subject to at least one selected from the group consisting of a roller type ball-mixing dispersion, a blade shear stirring dispersion and a high-pressure homogeneous dispersion.

15. The method as claimed in claim 10, wherein the elastic material processing oil includes at least one selected from the group consisting of a high naphthenic processing oil, an environmentally friendly rubber-processing oil TDAE, a paraffinic rubber-processing oil and a silicone rubber-processing oil (silicone oil).

16. The method as claimed in claim 10, wherein the carbon material is subjected to a surface treatment in advance.

17. The method as claimed in claim 16, wherein the surface treatment includes one of a physical modification and a chemical modification.

18. The method as claimed in claim 10, wherein the carbon material and the elastic material processing oil are mixed uniformly
